(19) United States
(12) Patent Application Publication
(10) Pub. No.: US 2012/0113514 A1
(43) Pub. Date: May 10, 2012

(54) Picoprojector with Image Stabilization [Image-Stabilized Projector]

(75) Inventor: Jeffrey Rodman, San Francisco, CA (US)

(73) Assignee: POLYCOM, INC., Pleasanton, CA (US)

(21) Appl. No.: 12/941,232

(22) Filed: Nov. 8, 2010

(51) Int. Cl. G02B 27/64

(52) U.S. Cl. 359/556; 359/554; 359/557; 359/555

(57) ABSTRACT

A handheld projector is provided with an image stabilization system that acts to reduce (or even eliminate) unwanted motion of the projected image due to unintended movement of the projector. In certain preferred embodiments, a solid-state motion sensor provides input to an image stabilization system that computes a corrective signal. In embodiments having optical image stabilization, the corrective signal is supplied to a mechanical actuator that moves one or more optical elements within the projector. Other embodiments have electronic image stabilization. In these embodiments, the corrective signal from the image stabilization system is used by the image generator to shift the image so as to compensate for movement of the projector.

### CROSS-REFERENCE TO RELATED APPLICATIONS

None

### STATEMENT REGARDING FEDERALLY SPONSORED RESEARCH OR DEVELOPMENT

Not Applicable

### BACKGROUND OF THE INVENTION

1. Field of the Invention

This invention relates to optical projectors. More particularly, it relates to an automatic apparatus for stabilizing a projected image.

2. Description of the Related Art Including Information Disclosed Under 37 CFR 1.97 and 1.98.

A handheld projector (also known as a pocket projector or mobile projector or picoprojector) is an emerging technology that applies the use of an image projector in a handheld device. It is a response to the emergence of compact portable devices such as mobile phones, personal digital assistants, and digital cameras, which have sufficient storage capacity to handle presentation materials but little space to accommodate an attached display screen. Handheld projectors involve miniaturized hardware and software that can project digital images onto a nearby viewing surface, such as a wall. Such systems typically comprise four main parts: the electronics, the laser light sources, the combiner optic, and the scanning mirrors. First, the electronics system turns the image into an electronic signal. Next the electronic signals drive laser light sources with different colors and intensities down different paths. In the combiner optics, the different light paths are combined into one path demonstrating a palette of colors. Finally, the mirrors copy the image pixel by pixel and can then project the image. This entire system is compacted into one very tiny chip. An important design characteristic of a handheld projector is the ability to project a clear image, regardless of the physical characteristics of the viewing surface.

Major advances in imaging technology have allowed the introduction of hand-held “picoprojectors.” Various manufacturers have produced handheld projectors that exhibit high-resolution, good brightness, and low energy consumption in a slightly larger format than pico.

A variety of light projection technologies exist today and more will likely be developed in the future. By way of example, many currently available micro projectors employ a single liquid crystal on silicon (LCOS) imager chip with single white LED which is recognized to offer low cost, high resolution, and fast response at the expense of color quality. Some newer models employ color-sequential (RGB) LEDs in either single or triple architecture which offers improved color quality similar to digital light processing (DLP) models but at a higher cost. Other projectors employ DLP technology. While slightly lower in resolution than their LCOS counterparts due to the tiny mirrors used in DLP technology, 3-LED DLP projectors are generally regarded as having higher contrast, better efficiency and lower power consumption as compared to color-sequential LCOS units and to have better color quality than white LED LCOS units. Laser scanning projectors offer very good color gamut and low power consumption due to the use of lasers as the light source and also present an image that is always in focus. Laser arrays, super-bright liquid crystal displays (LCD's) and plasma displays with projecting optics are additional examples of image projections technologies that may benefit from image stabilization methods and apparatus.

Handheld projectors can be used for different applications than simply small, conventional projectors.

Mobile phones now have the ability to store thousands of photos and can be used to take photographs with resolutions up to several megapixels. Viewing of the photos, however, is restricted by the phones' small displays. Projector phones allow photographs to be shared with a larger audience.

Handheld projectors, in particular projector phones, offer a multitude of new possibilities for mobile gaming. For example, a player might sketch a world on a sheet of paper or use an existing physical configuration of objects and let a physics engine simulate physical procedures in this world to achieve game goals.

Size reduction of mobile devices is often limited by the size of the display used. Apart from the display, a complete phone can be integrated in a headset. Picoprojectors integrated in headsets could be used as interaction devices e.g. using additional hand and finger tracking.

Pointer-based computer control can be achieved by combining a picoprojector with a webcam, a laser pointer and image processing software to enable full control of a computing system via the laser pointer. Pointer on/off actions, motion patterns (e.g. dwell, repetitive visit, circles, etc.) and more can all be mapped to events which generate standard mouse or keyboard events, or user-programmable actions.

Image stabilization (IS) is a family of techniques heretofore used to reduce blurring associated with the motion of a camera during exposure. Specifically, it compensates for pan and tilt (angular movement, equivalent to yaw and pitch) of a camera or other imaging device. It is used in image-stabilized binoculars, still and video cameras, and astronomical telescopes. With still cameras, camera shake is particularly problematic at slow shutter speeds or with long focal length (telephoto) lenses. With video cameras, camera shake causes visible frame-to-frame jitter in the recorded video. In astronomy, the problem of lens-shake is in addition to atmospheric variations which cause the apparent positions of objects to change.

In photography, image stabilization can often permit the use of shutter speeds 2-4 stops slower (exposures 4-16 times longer), although even slower effective speeds have been reported.

However, image stabilization does not prevent motion blur caused by the movement of the subject or by extreme movements of the camera. Image stabilization is only designed for and capable of reducing blur that results from normal, minute shaking of a lens due to hand-held shooting. Some lenses and camera bodies include a secondary panning mode or a more aggressive “active mode,” both described in greater detail below under optical image stabilization.

In photographic devices of the prior art, there are two types of implementation: lens-based; and, body-based stabilization. These refer to where the stabilizing system is located. Both have their advantages and disadvantages.

### Optical Image Stabilization

An optical image stabilizer, often abbreviated OIS, IS, or OS, is a mechanism used in a still camera or video camera that stabilizes the recorded image by varying the optical path to the sensor. This technology is implemented in the lens itself, or by moving the sensor as the final element in the optical path. The key element of all photographic optical stabilization systems is that they stabilize the image projected on the sensor before the sensor converts the image into digital information

### Lens-Based

One particular lens-based optical image stabilization system of the prior art works by using a floating lens element that is moved orthogonally to the optical axis of the lens using electromagnets. Vibration is detected using two piezoelectric angular velocity sensors (often called gyroscopic sensors), one to detect horizontal movement and the other to detect vertical movement. As a result, this type of image stabilizer only corrects for pitch and yaw axis motions, and cannot correct for rotation about the optical axis. Some lenses have a secondary mode that counteracts vertical camera shake only. This mode is useful when using a panning technique, and switching into this mode depends on the lens; sometimes it is done by using a switch on the lens, or it can be automatic.

One of the disadvantages of lens-based photographic image stabilization is that poor “Bokeh”—the blur or out-of-focus portion—can result because light passing through the lens is shifted from its true optical path when it projects out the rear element onto the sensor. This out-of-focus area around an image is a subjective quality, but highly valued by professional photographers.

### Sensor-Shift

In other photographic optical image stabilization systems, the sensor capturing the image is moved in such a way as to counteract the motion of the camera, a technology often referred to as mechanical image stabilization. When the camera rotates, causing angular error, gyroscopes encode information to the actuator that moves the sensor. The sensor is moved to maintain the projection of the image onto the image plane, which is a function of the focal length of the lens being used; modern cameras can acquire focal length information from the lens. Somer manufacturers use digital signal processors (DSPs) to analyze the image on-the-fly and then move the sensor appropriately.

An advantage of moving the image sensor, instead of the lens, is that the image can be stabilized regardless of the lens being used. This allows the stabilization system to work with any lens the photographer chooses and also reduces the weight and complexity of the lens.

In-body image stabilization requires the lens to have a larger output image circle because the sensor is moved during exposure and thus uses a larger part of the image.

With the increasing popularity of video in DSLRs, it is worth noting that sensor-shift stabilization does not function when recording video. The sensor must lock in place during video recording. Lens-based stabilization systems don't suffer from this drawback.

### Digital Image Stabilization.

True digital image stabilization is used in some video cameras. This technique shifts the electronic image from frame to frame of video, enough to counteract the motion. It uses pixels outside the border of the visible frame to provide a buffer for the motion. This technique reduces distracting vibrations from videos or improves still image quality by allowing an increase in the exposure time without blurring the image. This technique does not affect the noise level of the image, except in the extreme borders when the image is extrapolated.

The main disadvantage associated with this solution is that motion blur from shake under medium to low light conditions will be impossible to correct by the post processing image stabilization system, so in practice this technique only works well for short exposure times (daylight).

Many non-linear editing systems use stabilization filters that can correct a non-stabilized image by tracking the movement of pixels in the image and correcting the image by moving the frame. The process is similar to digital image stabilization but, since there is no larger image to work with the filter either crops the image to hide the motion of the frame or attempts to recreate the lost image at the edge through extrapolation.

### Orthogonal Transfer CCD

Used in astronomy, an orthogonal transfer CCD (OTCCD) actually shifts the image within the CCD itself while the image is being captured, based on an analysis of the apparent motion of bright stars. This is a rare example of digital stabilization for still pictures.

### Stabilizing the Camera [or Projector] Body

A technique that requires no additional capabilities of any camera body-lens combination consists of stabilizing the entire camera body externally rather than using an internal method. This is achieved by attaching a gyroscope to the camera body, usually utilizing the camera's built-in tripod mount. This allows the external gyro to stabilize the camera, and is typically employed in photography from a moving vehicle, when a lens or camera offering another type of image stabilization is not available.

Another technique for stabilizing a video or motion picture camera body is the Steadicam® system which isolates the camera from the operator's body using a harness and a camera boom with a counterweight.

### Projector Technology.

Digital Light Processing (DLP) is a trademark owned by Texas Instruments, representing a technology used in some video projectors. DLP is used in DLP front projectors (small standalone projection units) and DLP rear projection television.

DLP, along with LCD and LCOS, are the current display technologies behind rear-projection television, having supplanted CRT rear projectors.

The single-chip version of DLP and 3LCD are the two main technologies used in modern color digital projectors. 3LCD is a projector technology that employs three LCD panel chips in its image generation engine.

DLP is also one of the leading technologies used in digital cinema projection.

In March 2008, Texas Instruments announced the initial production of the DPP1500 chipset, which are micro projectors designed for use in mobile devices.

In DLP projectors, the image is created by microscopically small mirrors laid out in a matrix on a semiconductor chip, known as a Digital Micromirror Device (DMD). Each mirror represents one or more pixels in the projected image. The number of mirrors determines the resolution of the projected image. These mirrors can be repositioned rapidly to reflect light either through the lens or onto a heat sink (or “light dump”).

Rapidly toggling the mirror between these two orientations (essentially on and off) produces grayscales, controlled by the ratio of on-time to off-time.

There are two primary methods by which DLP projection systems create a color image: those utilized by single-chip DLP projectors, and those used by three-chip projectors. A third method, sequential illumination by three, colored light emitting diodes, is being developed. In yet another method, colored lasers are used as the light sources.

### Single-Chip Projectors.

In a projector with a single DLP chip, colors are produced either by placing a color wheel between a white lamp and the DLP chip or by using individual light sources to produce the primary colors (LEDs or lasers, for example). The color wheel is divided into multiple sectors: the primary colors: red, green, and blue, and in many cases secondary colors including cyan, magenta, yellow and white. The use of the secondary colors is part of a color performance system that processes the primary colors along with the secondary colors to create a broader spectrum of possible color combinations on the screen.

The DLP chip is synchronized with the rotating motion of the color wheel so that the green component is displayed on the DMD when the green section of the color wheel is in front of the lamp. The same is true for the red, blue and other sections. The colors are thus displayed sequentially at a sufficiently high rate that the observer sees a composite “full color” image. In early models, this was one rotation per frame. Now, most systems operate at up to 10× the frame rate.

### Three-Chip Projectors

A three-chip DLP projector uses a prism to split light from the lamp, and each primary color of light is then routed to its own DLP chip, then recombined and routed out through the lens.

### LED-Based DLPs

The first commercially-available LED-based DLP HDTV was introduced in 2006. This technology also eliminated the use of a color wheel. Besides long lifetime (eliminating the need for lamp replacement) and the elimination of the color wheel, other advantages of LED illumination include instant-on operation and improved color, with increased color saturation and improved color gamut to over 140% of the NTSC color gamut.

### LASER-Based DLPs

There are now commercially-available, laser-based, DLP displays which also eliminate the need for a color wheel. Three, separate, color lasers illuminate the digital micromirror device (DMD) in these projection devices, which is said to produce a richer, more vibrant color palette than other methods.

### BRIEF SUMMARY OF THE INVENTION

A projector is provided with an image stabilization system that acts to reduce (or even eliminate) unwanted motion of the projected image due to unintended movement of the projector. Because the projector may be physically small and have low mass, it may be difficult to physically stabilize. Any motion of the projector is magnified in the projected image. Handheld projectors (which may be stand-alone devices or incorporated into other devices such as a cell phones, computers or cameras) may benefit particularly by the practice of the invention.

In certain preferred embodiments, a solid-state motion sensor provides input to an image stabilization system that computes a corrective signal. In embodiments having optical (i.e., mechanical) image stabilization, the corrective signal is supplied to a mechanical actuator that moves one or more optical elements within the projector. Other embodiments have electronic image stabilization. In these embodiments, the corrective signal from the image stabilization system is used by the image generator to shift the image so as to compensate for movements of the projector.

### BRIEF DESCRIPTION OF THE SEVERAL VIEWS OF THE DRAWING(S)

FIG. 1 is a block diagram of a projector according to an embodiment of the invention having optical image stabilization.

FIG. 2 is a block diagram of a projector according to an embodiment of the invention that uses digital image stabilization.

### DETAILED DESCRIPTION OF THE INVENTION

The invention may best be understood by reference to certain illustrative embodiments.

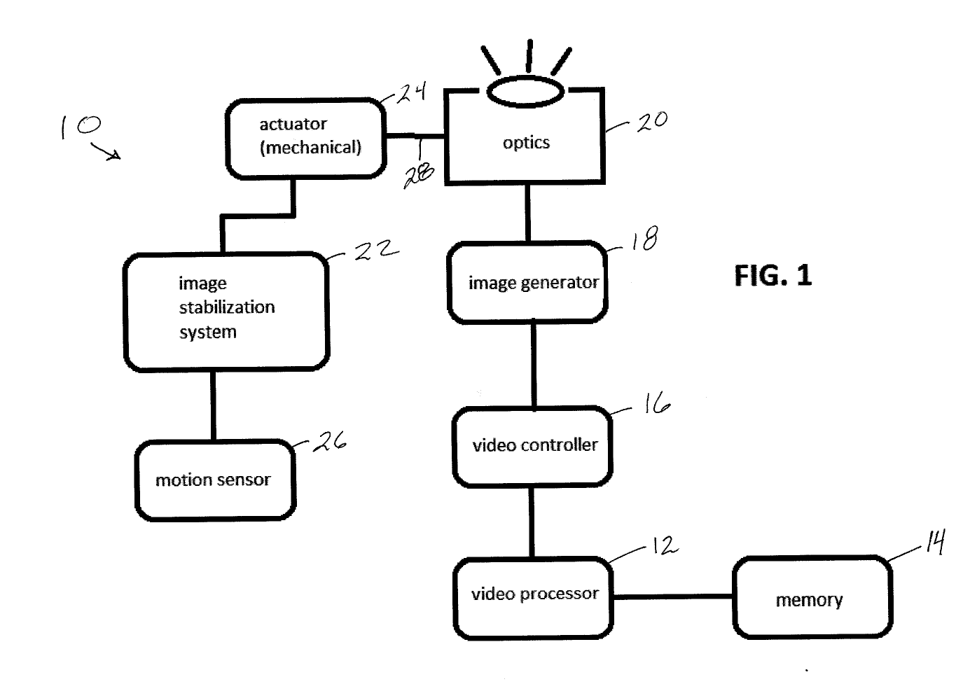

FIG. 1 shows projector 10 which comprises video processor 12 in data communication with memory or storage device 14 and video controller 16. In certain embodiments, memory 14 may be video random access memory (VRAM). Data representing an image may be stored in memory 14, processed by video processor 12 and sent to video controller 16 for display. Projector 10 may be a handheld projector. In some embodiments, projector 10 may be a subsystem of a portable electronic device—e.g., a digital camera, a mobile communications device, a portable computer, or the like.

Video controller 16 is connected to image generator 18. Image generator 18 may be any device capable of forming an optical image. Examples of some such devices currently available are described above in the section labeled “Background of the Invention.” In some embodiments, image generator 18 may comprise a light source. It yet other embodiments, image generator 18 may reflect or otherwise manipulate light provided by optics 20.

Projector 10 may comprise motion sensor 26. Motion sensor 26 may comprise an inertial measurement unit (IMU)—an electronic device that measures and reports the velocity, orientation, and/or gravitational forces acting on a body containing the IMU using a combination of accelerometers and gyroscopes. Motion sensor 26 may comprise solid-state or MEMS gyroscopes, accelerometers and/or magnetometers on all three axes. Microelectromechanical systems (MEMS) (also known as micro-electro-mechanical, or microelectronic and microelectromechanical systems) employ the technology of very small mechanical devices driven by electricity.

Motion sensor 26 is in data communication with image stabilization system 22. Image stabilization system 22 receives position and/or motion data from motion sensor 26 and computes a counteracting motion that, when applied to optics 20, reduces the apparent motion of the image projected by optics 20. This may be accomplished by moving one or more optical elements (e.g., lenses, light sources and/or mirrors) within optical system 20. The moving of the optical element(s) may be effected by mechanical actuator 24 which is connected to the one or more moveable optical elements via mechanical connector 28. In some embodiments of the invention, there may be a plurality of mechanical actuators 24 and mechanical connectors 28 that move a plurality of optical elements within optical system 20.

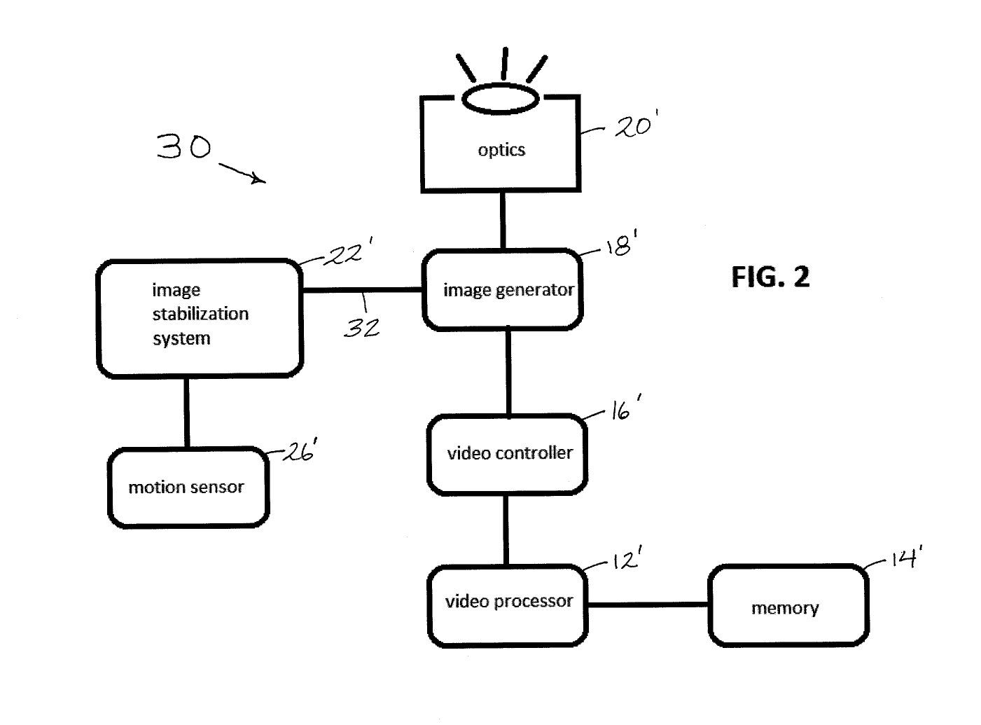

A representative embodiment of the invention having solid-state image stabilization is illustrated in FIG. 2.

FIG. 2 shows projector 30 which comprises video processor 12′ in data communication with memory or storage device 14′ and video controller 16′. In certain embodiments, memory 14′ may be video random access memory (VRAM). Data representing an image may be stored in memory 14′, processed by video processor 12′ and sent to video controller 16′ for display. Projector 30 may be a handheld projector. In some embodiments, projector 30 may be a subsystem of a portable electronic device—e.g., a digital camera, a mobile communications device, a personal digital assistant (PDA), a portable computer, or the like.

Video controller 16′ is connected to image generator 18′. Image generator 18′ may be any device capable of forming an optical image. Examples of some such devices currently available are described above in the section labeled “Background of the Invention.” In some embodiments, image generator 18′ may comprise a light source. It yet other embodiments, image generator 18′ may reflect or otherwise manipulate light provided by optics 20′.

Projector 30 may comprise motion sensor 26′. Motion sensor 26′ may comprise an inertial measurement unit (IMU)—an electronic device that measures and reports the velocity, orientation, and/or gravitational forces acting on a body containing the IMU using a combination of accelerometers and gyroscopes. Motion sensor 26 may comprise solid-state or MEMS gyroscopes, accelerometers and/or magnetometers on all three axes. Microelectromechanical systems (MEMS) (also known as micro-electro-mechanical, or microelectronic and microelectromechanical systems) employ the technology of very small mechanical devices driven by electricity.

Motion sensor 26′ is in data communication with image stabilization system 22′. Image stabilization system 22′ receives position and/or motion data from motion sensor 26′ and computes a corrective signal that, when input to image generator 18′ via electronic data connection 32, reduces the apparent motion of the image projected by optics 20′. In yet other embodiments of the invention, the corrective signal output of image stabilization system 22′ may be input to video controller 16′. It will be appreciated by those skilled in the art that, if a particular image is smaller than the maximum image size that a display device can display, then the image can be moved within the boundaries of the display to compensate for movement of the display device. For example, the position of an 800×600-pixel image may be moved around the 1680×1050 pixel array of a DLP-based projector to reduce the motion of the projected image on a screen. This corrective motion may be implemented in the video controller.

The invention may also be used in conjunction with an image projection apparatus adapted for projecting a three-dimensional (3D) image. A 3D variant may be implemented in the same way as that disclosed, above—i.e., either in the image generation portion of the apparatus, or in its projection system.

Practice of the invention is of particular benefit in handheld projectors and picoprojectors (which, lacking a fixed mounting, are subject to movement during routine use). The ever-increasing miniaturization and decreasing power requirements of integrated circuits and MEMS means that sophisticated image stabilization systems can be included in smaller projectors without undue size or cost penalties.

Although the invention has been described in detail with reference to certain preferred embodiments, variations and modifications exist within the scope and spirit of the invention as described and defined in the following claims.

What is claimed is:

1. A projector comprising:
at least one optical element;
a motion sensor; and,
an image stabilizer connected to the motion sensor and the optical element.

2. A projector as recited in claim 1 wherein the image stabilizer computes and outputs a signal based on an input received from the motion sensor.

3. A projector as recited in claim 2 additionally comprising a mechanical actuator responsive to the computed output signal and connected to the at least one optical element of the projector.

4. A projector as recited in claim 3 wherein the at least one optical element is a lens.

5. A projector as recited in claim 3 wherein the at least one optical element is a mirror.

6. A projector as recited in claim 3 wherein the at least one optical element is an digital micromirror device.

7. A projector as recited in claim 1 wherein the motion sensor comprises an accelerometer.

8. A projector as recited in claim 1 wherein the motion sensor comprises a MEMS gyroscope.

9. A projector as recited in claim 1 wherein the motion sensor comprises a vibrating structure gyroscope.

10. A projector as recited in claim 3 wherein the optical element is a light emitting device.

11. A projector comprising:
an image generator;
a motion sensor; and,
an image stabilizer connected to the motion sensor and the image generator.

12. A projector as recited in claim 11 wherein the image stabilizer computes and outputs a signal based on an input received from the motion sensor.

13. A projector as recited in claim 12 wherein the signal output by the image stabilizer is an input to the image generator.

14. A projector as recited in claim 13 wherein the image generator comprises a liquid crystal display.

15. A projector as recited in claim 13 wherein the image generator comprises an digital micromirror device.

16. A projector as recited in claim 13 wherein the image generator comprises a light source.

17. A projector as recited in claim 16 wherein the light source comprises a laser.

18. A projector as recited in claim 11 wherein the motion sensor comprises an accelerometer.

19. A projector as recited in claim 11 wherein the motion sensor comprises a MEMS gyroscope.

20. A projector as recited in claim 11 wherein the motion sensor comprises a vibrating structure gyroscope.

21. A projector as recited in claim 11 wherein the image generator is a 3-D image generator.
